(19) United States
(12) Patent Application Publication
(10) Pub. No.: US 2011/0020584 A1
(43) Pub. Date: Jan. 27, 2011

(54) COVERING TESSERA AND TESSERAE MANUFACTURING PROCESS

(76) Inventor: Dino Radice, Milano (IT)

Correspondence Address: SHERR & VAUGHN, PLLC, 620 HERNDON PARKWAY, SUITE 320, HERNDON, VA, 20170, US

(21) Appl. No.: 12/922,465

(22) PCT Filed: Mar. 20, 2008
(86) PCT No.: PCT/IT08/00187

§ 371 Date: Sep. 14, 2010

(51) Int. Cl. B44C 3/12; B44C 1/28; B44F 1/00; B32B 7/12; B32B 37/02; B32B 38/10

(52) U.S. Cl. 428/67; 428/195.1; 428/207; 428/209; 428/203; 428/210; 428/202; 156/60; 156/247

(57) ABSTRACT

A covering tessera (100) is described comprising: a body element (11), made of glass for example, an adhesive layer (12) having a surface which adheres to the body element and a decorative layer (13) which is anchored to the adhesive layer. According to an example, the adhesive layer is made of transparent material so that the decorative layer can be seen.

### FIELD OF THE INVENTION

The present invention refers to tesserae, of the type for mosaics, and a process for the production of tesserae.

### State of the Art

As is known, a tessera in the art of mosaics is a fragment of any material which is used for the composition of pictorial figures. The materials used are typically stones or glass. Said tesserae can consist of semi-precious and precious stones or be made of glass coloured by means of pigments melted inside the glass paste or they can include gold leaves. The form and dimensions of the tesserae can also vary according to the dimensions of the figure to be obtained and the precision of the same.

Tiles are also known which are architectural elements used to cover the surfaces of floors and walls as a finish and also for artistic purposes.

Tiles can have many different geometrical shapes (square, rectangular, hexagonal etc.), varying dimensions and can be made of brick, marble chips, marble, ceramic, concrete, etc.

For the purposes of the present invention, the term “tessera” refers to any architectural element that can be used to cover surfaces, walls, floors or other and which has a decorative effect, if applied alone or if applied together with several tesserae, as occurs, for example, in a mosaic, on a floor or in a wall covering. Therefore, according to the present invention, the “tessera” includes, for example, both a tile and a tessera for mosaics. In accordance with the invention, a covering panel is a structure that bears several tesserae.

### SUMMARY OF THE INVENTION

The object of the present invention is to propose a tessera which has innovative structural characteristics and which can be obtained, preferably, by means of a manufacturing process that favours customisation of the decorative effect provided by the individual tessera or by the entire covering with several tesserae.

The object of the present invention is achieved by a tessera as defined in the attached claim 1 and its preferred embodiments described by the claims from 2 to 22. The present invention also concerns a covering panel as defined in claim 23 and a particular embodiment thereof described by claim 24.

According to a further aspect, the present invention concerns a process for the production of tesserae as defined by claim 25 and the preferred embodiments thereof described by claims 26 to 29.

### BRIEF DESCRIPTION OF THE FIGURES

The present invention is described below in detail, by way of non-limiting example, with reference to the accompanying drawings, in which:

FIG. 1 shows a lateral view of a first covering panel bearing tesserae in accordance with an example of embodiment of the invention;

FIG. 2 shows a lateral view of said tessera;

FIG. 3 shows a lateral view of a second covering panel in accordance with an example of embodiment of the invention;

FIG. 4 shows a lateral view of a third covering panel in accordance with an example of embodiment of the invention;

FIG. 5 shows a lateral view of a fourth covering panel in accordance with an example of embodiment of the invention;

FIG. 6 shows a lateral view of a fifth covering panel in accordance with an example of embodiment of the invention;

FIG. 7 shows a lateral view of a sixth covering panel in accordance with an example of embodiment of the invention;

FIG. 8 shows a lateral view of a first multilayer decorative structure which can be used for the production of said tesserae according to an example of embodiment of the invention;

FIG. 9 shows a lateral view of a second multilayer decorative structure which can be used for the production of said tesserae according to an embodiment of the invention;

FIG. 10 shows a lateral view of a third multilayer decorative structure which can be used for the production of said tesserae according to an embodiment of the invention.

### DETAILED DISCLOSURE OF PARTICULAR EMBODIMENTS

With reference to the drawings accompanying the present description, it should be noted that layers, materials and components which are identical or analogous will be indicated by the same reference numbers.

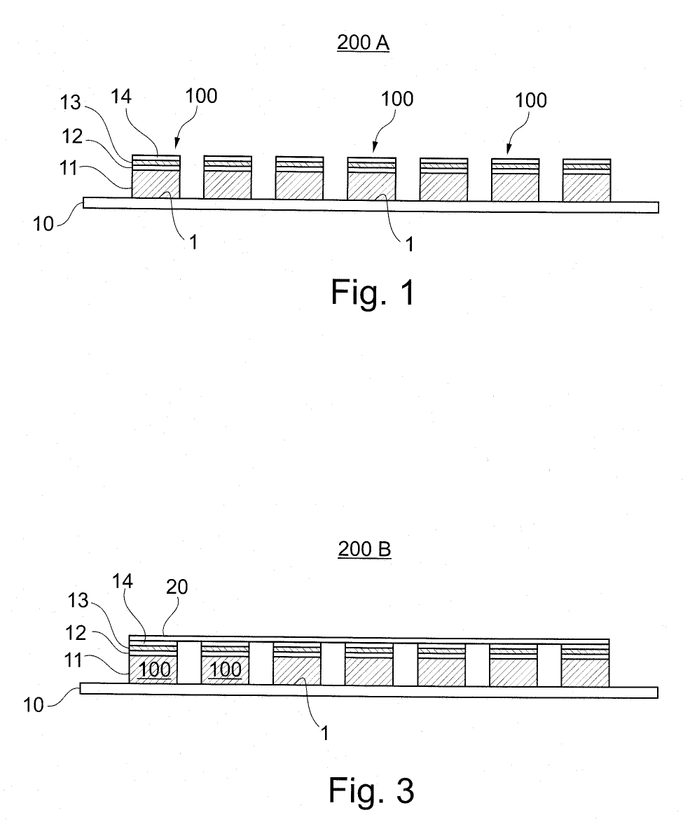

FIG. 1 shows a covering panel 200A in accordance with a first embodiment of the present invention. The panel 200A comprises a plurality of tesserae 100 and a supporting element 10 on which the tesserae 100 are arranged. The tesserae 100 are distributed, for example, in the manner of an array in order to cover a pre-determined surface.

Initially reference is made to only one of the tesserae 100, which are substantially the same as one another in terms of structure, barring differences in the decorative content.

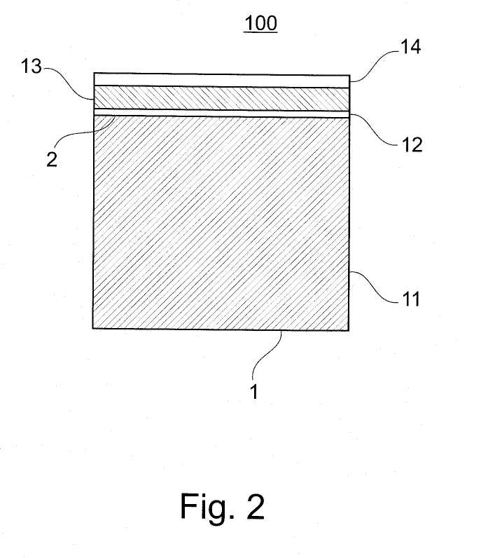

The tessera 100 (also shown in FIG. 2) comprises a body element 11, an adhesive layer 12 and decorative layer 13. Advantageously, a protective layer 14 is also provided.

In greater detail, according to an example, the body element 11 is a base tessera made of transparent material (typically in the form of a parallelepiped or cube-shaped) which defines a first face 1 and an opposite second face 2. According to a preferred embodiment, the body element 11 is made of glass. Alternatively, the following transparent materials can be used: transparent synthetic and/or plastic fibres, transparent minerals.

With reference to possible examples of dimensions: the body element 11 has a thickness (distance between the walls 1 and 2) of between 0.5 mm and 10 mm, preferably between 1 mm and 5 mm and width and depth between 1 mm and 20 mm, preferably between 2 and 10 mm.

The adhesive layer 12 is arranged to cover the second face 2 of the body element 11 (further details will be provided below) and is, preferably, made of a polymeric material and, for example, comprises one of the following materials: solvent-based polymeric material, water-based polymeric material, polymeric material based on resins polymerised by means of UV light. By way of example, the thickness of the adhesive layer 12 can be between 0.005 mm and 3 mm, preferably between 0.5 mm and 1.5 mm.

The decorative layer 13 is anchored to the adhesive layer 12 and contains materials, for example pigments, which provide the required decoration of the tessera 100. The materials that can be used to produce said decorative layer 13 will be described below. For example, the decorative layer 13 has a thickness of between 250 and 1000 angstrom and, in particular, can be approximately 400 angstrom.

The protective layer 14 which can have a thickness of between 0.005 mm and 3 mm, preferably between 0.5 mm and 1.5 mm, is arranged on the decorative layer 13.

The protective layer 14 has protective characteristics such that it constitutes a barrier to the penetration or migration of external agents that can attack the decorative layer 13, for example acids, alkalis, bases or chlorine, such as chlorine used in swimming pools. According to embodiment examples, the protective layer 14 is made of polymeric material which can comprise one of the following materials: solvent-based polymeric material, water-based polymeric material, polymeric material based on resins polymerised by UV light. Advantageously, the protective layer 14 will also have anti-abrasive characteristics.

Returning to the panel 200A of FIG. 1, the supporting element 10 is a film (which can be wound like a ribbon for example) made, preferably, of a polyester resin or bioriented polyethylene terephthalate PET. For production of the supporting element 10, the following materials can also be used: paper and/or synthetic fibres, polypropylene PP, polyvinylchloride PVC, polycarbonate.

As will be clarified below, said supporting element 10 provides a support for the tesserae 100 during their manufacture and is useful during installation of the panel. For example, the supporting element 10 is a film having a thickness of between 8 microns and 500 microns, preferably between 100 and 300 microns. The tesserae 100 are arranged on the supporting element 10 by interposition of an adhesive which keeps them in position also during installation but at the same time allows detachment from the tesserae.

It should be noted that the panel 200A as shown in FIG. 1 can be used for installation by applying the side of the panel which comprises the protective layers 14 to an installation medium positioned on an application support such as a wall or a floor, for example. Advantageously, the installation medium can be an adhesive cement-based mortar (for example the product marketed by MAPEI-Italy).

Following installation, after hardening of the cement-based mortar, the supporting element 10 can be removed. In this case the decorative layers 13 are visible through the body elements 11 and the adhesive layers 12, which will, in this case, be made of transparent material. The plurality of tesserae 100 represents a mosaic decoration or a decorative type covering like the one that can be obtained with tiles.

FIG. 3 shows a second panel 200B in accordance with another embodiment which provides, in addition to the elements already specified with reference to the panel 200A of FIG. 1, also a conglomeration mesh for the various tesserae 100, fixed to each protective layer 14.

Said conglomeration mesh 20 keeps the tesserae 100 together during the installation operations, also permitting, via its apertures, passage of the cement-based mortar or other installation medium. The conglomeration mesh 20 can be made of nylon or other plastic and/or synthetic materials.

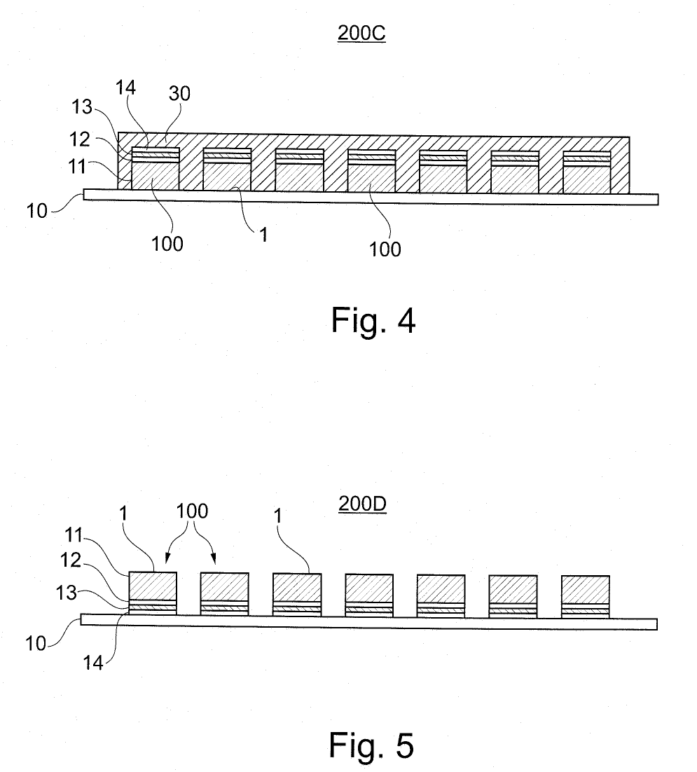

FIG. 4 shows a third panel 200C according to a further embodiment which provides, in addition to the elements already specified with reference to the panel 200A of FIG. 1, also a conglomeration and sealing matrix 30 for the tesserae 100. The material of the matrix 30 covers the protective layer 14 and penetrates between the gaps existing between the various tesserae 100, adhering to the lateral walls of said tesserae 100. For example, said conglomeration matrix 30 is such as to have at least one of the following characteristics: antibacterial, flexible, resistant to humidity and the aggression of chemical agents. In particular, the conglomeration matrix 30 is made of a material based on resins polymerised by UV light, more preferably it is a solvent-based polymeric material. The flat regions of the matrix 30 have, for example, a thickness of between 0.5 mm and 5 mm, preferably between 2 mm and 3 mm.

Also for the second panel 200B and third panel 200C, once the supporting element 10 has been removed, the decorative layers 13 are visible from the first face 1 due to the transparency of the body element 11 and of the adhesive layer 12.

FIGS. 5, 6 and 7 show a fourth panel 200D, a fifth panel 200E and a sixth panel 200F respectively, according to further embodiments of the invention. The embodiments of FIGS. 5, 6 and 7 use the same tessera 100 as shown in FIG. 2 but positioned upside-down with respect to the embodiments of FIGS. 1, 3 and 4.

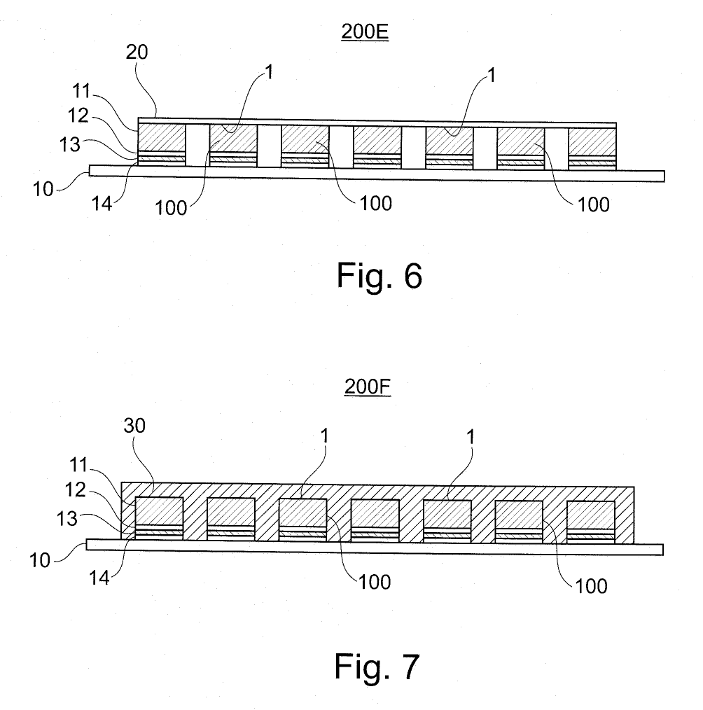

In other words, in the fourth panel 200D (FIG. 5), in the fifth panel 200E (FIG. 6) and in the sixth panel 200F (FIG. 7), the tesserae 100 (FIG. 2) are arranged so that the protective layer 14 is in contact (by means of relative adhesive) with the supporting element 10.

In particular, the fourth panel 200D is not provided with conglomeration elements, analogously to the first panel 200A, while the fifth panel 200E comprises a conglomeration mesh 20, analogous to that of the second panel 200B but adhering to the first faces 1 of the tesserae 100. The sixth panel 200F comprises a conglomeration matrix 30, analogous to that of the third panel 200C but covering the first faces 1 of the tesserae 100.

Installation of the fourth panel 200D, fifth panel 200E and sixth panel 200F can be performed as already described but, for these variations, after removal of the supporting element 10, the protective layer 14 (which will be transparent) will be exposed to view so that the underlying decorative layers 13 can be seen. For these three versions (200D, 200E, 200F) it is not necessary for the adhesive layer 12 and the body element 11 to be transparent. For example, the body element 11 can also be made of the following materials: ceramic, porcelain, metal, wood or non-transparent minerals.

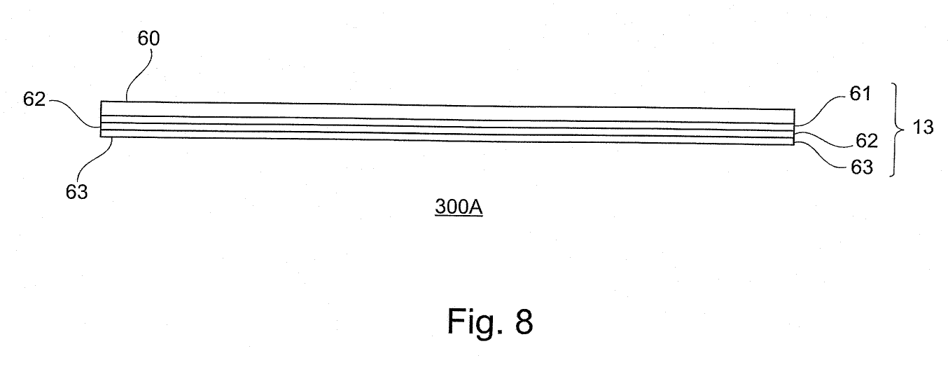

FIG. 8 refers to a first particular embodiment of the decorative layer 13 comprising: a first decorative layer 63, a second decorative layer 62 and a layer of detachment material 61.

According to an example, the first decorative layer 63 is a metallization layer, for example comprising at least one material chosen from the following group: Au, Al, Ag, Cu, Cr, Zns, Zrs, SiOx, TiOx, ITO (Indium-tin oxide). The metallization 63 can be obtained with known technologies for the deposition of metals (for example, vacuum deposition) and has, for example, a thickness of between 250 and 1000 angstrom, in particular approximately 400 angstrom.

The second decorative layer 62 (on which the first decorative layer 63 lies) comprises any substance suitable for appropriately colouring it in accordance with the desired decoration. In particular, said substances can include pigments and/or dyes of organic or inorganic type. According to an implementation example, the decorative layer 62 comprises a base material in which the dyes and/or pigments are dissolved or simply added and can therefore be soluble or insoluble. The supporting material can be a material belonging to the group: natural polymers, synthetic polymers, thermohardening or thermoplastic polymers, acrylic-polyurethane polymers. The pigments can be coloured pigments, pearlescent pigments or iridescent pigments. For decorating and colouring purposes, micronised materials, powders, metals (gold, for example), titanium dioxide or holographic microincisions can also be used.

Said second decorative layer 62 has, for example, a thickness of between 0.1 microns and 30 microns, preferably between 0.15 microns and 15 microns.

The layer of detachment material 61 has an advantageous function for the manufacturing process of the tesserae 100, as will be further clarified below. Said detachment layer 61 can have, for example, a thickness of between 0.05 microns and 0.5 microns, preferably between 0.08 microns and 0.3 microns.

In the operating phase to which FIG. 8 refers, the layer of detachment material 61 fixes the first and the second decorative layer 63 and 62 to a supporting layer 60 such as a film, preferably made of plastic. For example, the material of the supporting layer 60 is a polyester resin, in particular PET, or polypropylene (PP), polyvinyl chloride (PVC) or polycarbonate. Said supporting layer 60 has, for example, a thickness of between 8 microns and 50 microns, preferably between 12 microns and 19 microns.

The supporting layer 60, together with the detachment layer 61 and the decorative layers 62 and 63, forms a first multilayer decorative structure 300A which can be used for manufacture of the tesserae 100.

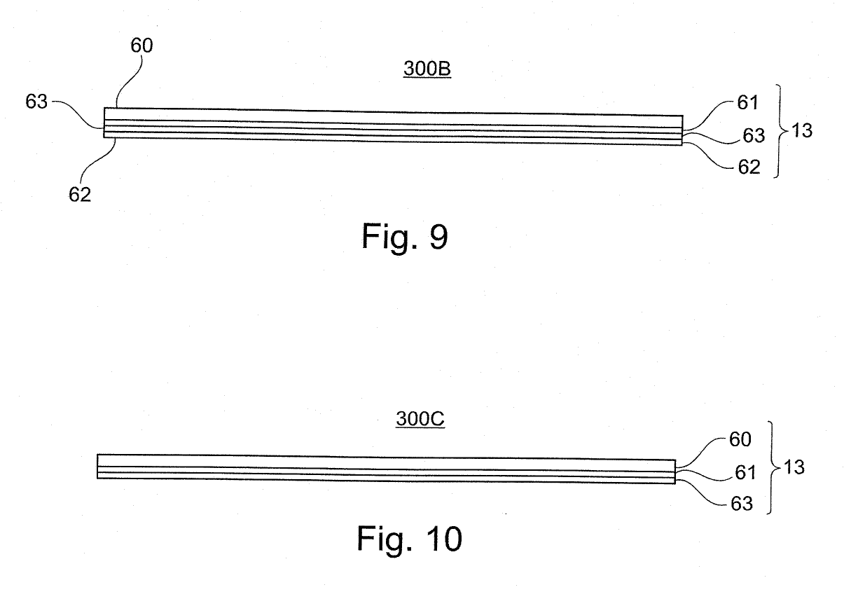

It should be noted that according to other embodiments, the first decorative layer 63 and the second decorative layer 62 can be arranged inverted with respect to FIG. 8. In other words, as can be seen in FIG. 9, in a second multilayer decorative structure 300B, the first decorative layer 63 has one face in contact with the detachment layer 61 and the second decorative layer 62 is arranged in contact with the other face of the first decorative layer 63.

It should be observed that the metallization corresponding to the first decorative layer 63 could be of consistency and thickness such as to be opaque, i.e. not transparent. In this case, the relative arrangement of the first decorative layer 63 and the second decorative layer 62 and the choice between one of the embodiments 200A-200F will be such as to ensure that the decoration to be shown is actually visible after installation and is not covered by opaque layers.

Furthermore, according to another embodiment, shown in FIG. 10 with reference to a third multilayer decorative structure 300C, the second decorative layer 62 (or the first decorative layer 63) may not be present.

The manufacturing process of the panel 200A will now be described. The body elements 11, for example, already appropriately separated and spaced, are placed on the supporting element 10.

Subsequently, the adhesive layer 12 is deposited on the second face 2 of each tessera 100. Said deposition can be performed, preferably and not exclusively, by spray means such as spray heads, for example of the ink jet type. The heads are controlled by a suitable software program able to control, by selectively spraying (in different times/phases) the adhesive material onto each individual body element 11.

For deposition of the adhesive layers 12 the method of digital airbrushing, known per se, can also be used or other digital printing methods. The air brushing method uses an air brush, i.e. a small pen-shaped tool which, when connected to a small air compressor, can be used to spray on the substance to be deposited in a precise manner.

Another method of application of the adhesive on the body elements 11 is based on a screen-printing system. The system permits transfer of the adhesive to be released through silk screens partially “cleared” in the position and in the portion of the individual body elements 11 which will be covered with the adhesive. However, this system does not permit electronic control (programmed and variable) of transfer of the adhesive onto the individual tesserae, since the adhesive is transferred (released) by a mechanical type tool, therefore this tool must be replaced when the form or the position of the adhesive to be transferred is changed.

Subsequently, the first multilayer decorative structure 300A (FIG. 8) rests on the adhesive layers so that corresponding portions of the first decorative layer 63 adhere to the various adhesive layers 12.

The adhesive of the layers 12 is hardened (for example by means of heat or UV light) so as to ensure a high adhesion force with the first multilayer decorative structure 300A.

The supporting layer 60 of the first panel 300A is raised (by means of an appropriate machine) so that the detachment layer 61 breaks and permits removal of the supporting layer 60, without the decorative layers 63 and 62 which remain (with part of the detachment layer 61) anchored to the corresponding layers of adhesive 12, forming the decorative layers 13 (FIG. 1). Analogous operations are performed for the multilayer decorative structures 300B and 300C.

The corresponding protective layers 14 are arranged above the decorative layers 13.

If scheduled, the conglomeration mesh 20 or the conglomeration matrix 30 can be deposited, obtaining the second covering panel 200B (FIG. 3) or the third covering panel 200C (FIG. 4) respectively. For production of the fourth covering panel 200D (FIG. 5), the same method as described previously to obtain the first panel 200A (FIG. 1) is used. After production of the first panel 200A, another supporting element 10 is made to adhere to the protective layers 14 (FIG. 1), while the first panel in contact with the first faces 1 of the body elements 11 is removed (due to the slight adhesion force of the element 10), thus obtaining the fourth covering panel 200D. By applying the conglomeration mesh 20 or the conglomeration matrix 30, the fifth covering panel 200E (FIG. 6) and the sixth covering panel 200F (FIG. 7) are obtained respectively.

It should be noted that the tessera 100 is of high quality both structurally and aesthetically and the production process described is particularly advantageous. In fact, the methods of use of the detachment material for application of the decoration are very effective, do not excessively complicate the manufacturing process and favour automation of the entire process.

It should also be noted that the possibility of positioning the adhesive for anchoring to the decoration using spray heads permits an electronic type control which results in a very high quality and resolution and allows mosaics representing particularly complex images to be obtained. The techniques of deposition of metal, pigments or dyes, or holographic microincisions for production of the decoration permit great flexibility and customisation of the process, obtaining many different types of mosaics. In particular it is possible to obtain mosaics that represent very complex images and with a high resolution.

It should be noted that, in accordance with a further example of the present invention, it is also possible for a covering panel to contain some tesserae 100 of the type described and also other types of tesserae such as conventional ones or tesserae obtained by means of dye printing processes.

Lastly, the present invention can be modified and varied in numerous ways, all falling within the attached claims, while the technical details can vary according to requirements.

1-29. (canceled)

30. Covering tessera comprising:
a body element defining a first face and a second face positioned opposite to said first face;
an adhesive layer having a first adhesive layer surface which adheres to the second face of the body element and a second adhesive layer surface positioned opposite to said first adhesive layer surface; and
a decorative layer having a first decorative layer face anchored to said second adhesive layer surface.

31. The covering tessera of claim 30, further comprising a protective layer arranged on a second decorative layer face opposite the first decorative layer face anchored to the second adhesive layer surface.

32. The covering tessera of claim 31, further comprising a portion of a fixing structure arranged on one of said protective layer and said first face of said body element.

33. The covering tessera of claim 30, wherein said decorative layer includes pigments and/or dyes.

34. The covering tessera of claim 33, wherein said decorative layer comprises a metallization layer.

35. The covering tessera of claim 34, wherein said metallization layer comprises at least one material chosen from the group consisting of Au, Al, Ag, Cu, Cr, Zns, Zrs, SiOx, TiOx and Indium-tin oxide (ITO).

36. The covering tessera of claim 34, wherein said decorative layer further comprises a layer with pigments facing said metallization layer.

37. The covering tessera of claim 36, wherein said layer with pigments comprises at least one of natural polymers, synthetic polymers, thermo-hardening polymers, thermoplastic polymers and acrylic-polyurethane polymers.

38. The covering tessera of claim 36, wherein said pigments comprise at least one of coloured pigments, pearlescent pigments and iridescent pigments.

39. The covering tessera of claim 30, wherein said decorative layer includes at least one of holographic micro-incisions and metals.

40. The covering tessera of claim 36, wherein said metallization layer is positioned between said adhesive layer and said layer with pigments.

41. The covering tessera of claim 36, wherein said layer with pigments is positioned between said adhesive layer and said metallization layer.

42. The covering tessera of claim 30, wherein at least one of said body element and said adhesive layer is transparent so as to permit the decorative layer to be optically seen.

43. The covering tessera of claim 30, wherein said adhesive layer comprises at least one polymer.

44. The covering tessera of claim 43, wherein said polymer of the adhesive layer comprises one of a solvent-based polymer, a water-based polymer, and a polymer based on resins polymerised by UV light.

45. The covering tessera of claim 30, wherein said body element comprises one of glass, transparent synthetic fibres, transparent plastic fibres, transparent minerals, ceramic, porcelain, a combination of ceramic and porcelain, metals, wood and non-transparent minerals.

46. The covering tessera of claim 31, wherein said protective layer acts as a barrier against the penetration of aggressive agents for said decorative layer.

47. The covering tessera of claim 30, wherein said decorative layer further comprises a layer of detachment material resulting from transfer of said decorative layer onto said adhesive layer.

48. A covering panel, comprising:
a supporting panel element; and
a first covering tessera and at least one second covering tessera having a relative exposed face arranged on said supporting element and an installation face, wherein each tesserae comprises:
a body element defining a first face and a second face positioned opposite to said first face;
an adhesive layer having a first adhesive layer surface which adheres to the second face of the body element and a second adhesive layer surface positioned opposite to said first adhesive layer surface; and
a decorative layer having a first decorative layer face anchored to said second adhesive layer surface.

49. The covering panel of claim 48, wherein said supporting element comprises one of paper fibres, synthetic fibres, polyester resin, polypropylene (PP), bi-oriented polyethylene terephthalate (PET), polyvinylchloride (PVC) and polycarbonate.

50. A process of manufacturing panels bearing covering tesserae, comprising:
providing a plurality of body elements of each tessera, each body element defining a first face and an opposite second face;
arranging an adhesive layer on one of said faces of each body element; and then
arranging a decorative layer on each respective adhesive layer.

51. The process of claim 50, wherein arranging the decorative layer comprises:
providing a supporting layer;
arranging on said supporting layer a layer of detachment material which identifies a free adhesion surface;
arranging on said free adhesion surface of the detachment material at least one first decorative layer which identifies a free adhesion surface;
arranging the supporting layer so that the free adhesion surface of said at least one first decorative layer anchors to each adhesive layer of each respective tessera; and then
removing the supporting layer by breaking said layer of detachment material and permitting said at least one decorative layer to be transferred to said adhesive layer.

52. The process of claim 51, wherein before removing the supporting layer, said adhesive layer is hardened by one of heat treatment and ultraviolet rays.

53. The process of claim 50, wherein arranging an adhesive layer on one of said faces of each body element comprises:
providing a spray device adapted for electronic control;
feeding said means with adhesive material;
selectively spraying the relative adhesive layer on each respective tessera via said spray device.

54. The process of claim 50, further comprising:
arranging a protective layer on a surface of the decorative layer not anchored to the adhesive layer.
